(19) United States
(12) Patent Application Publication
(10) Pub. No.: US 2012/0217827 A1
(43) Pub. Date: Aug. 30, 2012

(54) ELECTROMECHANICAL DEVICE, MOVABLE BODY, AND ROBOT

(75) Inventors: Kesatoshi TAKEUCHI, Shiojiri (JP); Yojiro OKAKURA, Suwa (JP)

(73) Assignee: SEIKO EPSON CORPORATION, Tokyo (JP)

(21) Appl. No.: 13/405,560

(22) Filed: Feb. 27, 2012

(30) Foreign Application Priority Data
Feb. 28, 2011 (JP) 2011-041908

(51) Int. Cl. H02K 7/00; H02K 21/02

(52) U.S. Cl. 310/66; 310/179; 310/154.02

(57) ABSTRACT

An electromechanical device includes at least one magnetic coil formed of an electric wire coated with a first insulating material wound a plurality of times to have a ring-like shape, and an insulating section made of a second insulating material and disposed so as to cover at least apart of the magnetic coil, and a withstand voltage between an outside of the insulating section and the magnetic coil across the insulating section is higher than a withstand voltage between the electric wires adjacent to each other in the magnetic coil.

### BACKGROUND

1. Technical Field

The present invention relates to an isolation technology to a voltage caused in a magnetic coil of an electromechanical device.

2. Related Art

As an insulated wire for forming a coil, there has been known an insulated wire formed by coating a conductor with an insulating material (JP-A-2009-272191).

Although, in general, there is provided an insulating layer having a thickness enough for fulfilling the requirement of the withstand voltage of the magnetic coil, an air space is caused between the winding wires with a circular cross-section of the magnetic coil in the process of forming the magnetic coil of an electric motor, and the air space causes the following problems.

1. The lamination factor of the magnetic coil is degraded.

2. Conduction of the heat generated in the magnetic coil to an external case is hindered.

3. The working process of defoaming (elimination of the air space) for eliminating the air spaces takes long time when forming a resin-molded magnetic coil.

In order to solve the problems described above, heating (by applying a current to the magnetic coil to cause Joule heat) is performed after winding the magnetic coil and then pressurizing the magnetic coil when forming the magnetic coil thus wound to thereby minimize the air spaces.

On this occasion, although the thickness of the insulating layer between the winding wires in the magnetic coil is reduced, no problems occur because there is no chance for the electric potential difference between the winding wires of the same phase to become so large. However, between the magnetic coils of different phases, between the magnetic coil and the rotor, or between the magnetic coil and the coil back yoke, there arises a necessity of coping with a high withstand voltage in, for example, a withstand voltage test.

### SUMMARY

An advantage of some aspects of the invention is to achieve improvement in withstand voltage between a magnetic coil and other members, and at the same time realizing improvement in performance and downsizing of an electric motor.

### APPLICATION EXAMPLE 1

This application example of the invention is directed to an electromechanical device including at least one magnetic coil formed of an electric wire coated with a first insulating material wound a plurality of times to have a ring-like shape, and an insulating section made of a second insulating material and disposed so as to cover at least apart of the magnetic coil, wherein a withstand voltage between an outside of the insulating section and the magnetic coil across the insulating section is higher than a withstand voltage between the electric wires adjacent to each other in the magnetic coil.

According to this application example, since the withstand voltage between the outside of the insulating section and the magnetic coil across the insulating section is higher than the withstand voltage between the electric wires adjacent to each other in the magnetic coil, it is possible to prevent the current from leaking between the outside and the magnetic coil across the insulating section to thereby enhance the withstand voltage of the electromechanical device.

### APPLICATION EXAMPLE 2

This application example of the invention is directed to the electromechanical device of Application Example 1, wherein the withstand voltage of the insulating section fulfills a withstand voltage value specified by a standard related to the electromechanical device, and the withstand voltage between the electric wires adjacent to each other in the magnetic coil is lower than the withstand voltage value specified by the standard.

According to this application example, by forming the insulating section so as to have the withstand voltage property fulfilling the withstand voltage value specified by the standard related to the electromechanical device, even if the withstand voltage between the electric wires adjacent to each other in the magnetic coil is set to be lower than the withstand voltage value specified by the standard in order to reduce the thickness of the coating of the electric wire, the current leakage between the outside of the insulating section and the magnetic coil across the insulating section and the current leakage between the electric wires adjacent to each other in the magnetic coil can be prevented. As a result, downsizing and improvement in performance of the electromechanical device can be realized.

### APPLICATION EXAMPLE 3

This application example of the invention is directed to the electromechanical device according to Application Example 1 or 2, wherein a permanent magnet disposed so as to be opposed to the magnetic coil is further provided, and the insulating section is disposed on the permanent magnet side of the magnetic coil.

According to this application example, the withstand voltage between the magnetic coil and the permanent magnet can be enhanced.

### APPLICATION EXAMPLE 4

This application example of the invention is directed to the electromechanical device according to any of Application Examples 1 to 3, wherein a coil back yoke is further provided, the magnetic coil is disposed between the permanent magnet and the coil back yoke, and the insulating section is disposed between the magnetic coil and the coil back yoke.

According to this application example, the withstand voltage between the magnetic coil and the coil back yoke can be enhanced.

### APPLICATION EXAMPLE 5

This application example of the invention is directed to the electromechanical device according to any of Application Examples 1 to 4, wherein a number of the magnetic coils is plural, and the insulating section is disposed between the plurality of magnetic coils.

According to this application example, the withstand voltage between the two magnetic coils can be enhanced.

### APPLICATION EXAMPLE 6

This application example of the invention is directed to the electromechanical device according to any of Application Examples 1 to 5, wherein the second insulating material is selected from a group consisting of a titanium oxide-containing silane coupling agent, parylene, epoxy, silicone, and urethane.

According to this application example, a thinner insulating section with higher withstand voltage property can be formed by using the materials described above.

### APPLICATION EXAMPLE 7

This application example of the invention is directed to a movable body including the electromechanical device of any of Application Examples 1 to 6.

### APPLICATION EXAMPLE 8

This application example of the invention is directed to a robot including the electromechanical device of any of Application Examples 1 to 6.

It should be noted that the invention can be implemented in various forms such as an electromechanical device such as an electric motor or a power-generating device, a movable body using the electromechanical device, or a robot.

### BRIEF DESCRIPTION OF THE DRAWINGS

The invention will be described with reference to the accompanying drawings, wherein like numbers reference like elements.

FIGS. 1A and 1B are explanatory diagrams showing a configuration of an electric motor according to an embodiment of the invention.

FIG. 2A is an explanatory diagram of magnetic coils developed along a cylindrical surface on which the magnetic coils are disposed, and viewed from the center of a rotary shaft.

FIG. 2B is an explanatory diagram showing the cross-section along the 2B-2B cutting line in FIG. 2A in a developed manner.

FIG. 2C is an explanatory diagram showing the cross-section along the 2C-2C cutting line in FIG. 2A in an enlarged manner.

FIGS. 3A and 3B are explanatory diagrams showing an example of a silane coupling agent constituting insulating layers.

FIG. 4 is an explanatory diagram showing an example of the silane coupling agent including titanium oxide or silicon dioxide.

FIGS. 5A and 5B are explanatory diagrams showing other examples of the insulating material.

FIG. 6 is an explanatory diagram showing a relationship between the magnetic flux density and the distance from the surface of permanent magnets by the distance between the surface of the permanent magnets and a coil back yoke having a constant thickness (2.0 mm).

FIG. 7 is an explanatory diagram for comparing the electric motor according to the invention with an electric motor of related art.

FIG. 8 is an explanatory diagram showing a modified example.

FIG. 9 is an explanatory diagram showing another modified example.

FIGS. 10A and 10B are explanatory diagrams showing another modified example.

FIG. 11 is an explanatory diagram showing an electric bicycle (an electric power-assisted bicycle) as an example of a movable body using a motor/generator according to another modified example of the invention.

FIG. 12 is an explanatory diagram showing an example of a robot using an electric motor according to another modified example of the invention.

FIG. 13 is an explanatory diagram showing a railroad vehicle using an electric motor according to a modified example of the invention.

### DESCRIPTION OF AN EXEMPLARY EMBODIMENT

### A. EMBODIMENT

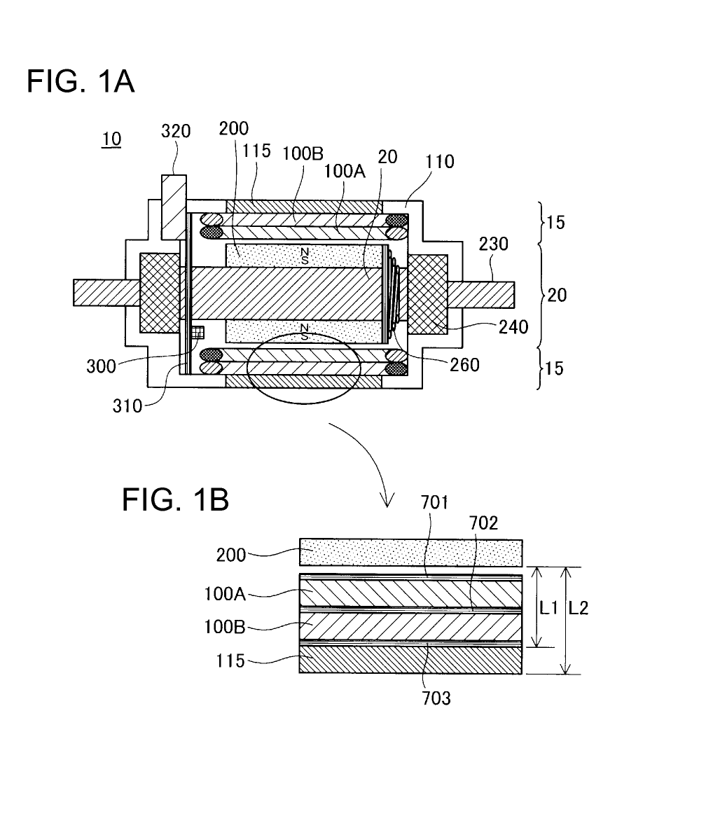

FIGS. 1A and 1B are explanatory diagrams showing a configuration of an electric motor according to a first embodiment. The electric motor 10 is provided with a stator 15 and a rotor 20. The stator 15 is disposed outside. Inside the stator 15, there is formed a space having a roughly cylindrical shape, and the rotor 20 having a roughly cylindrical shape is disposed in the roughly cylindrical space.

The stator 15 is provided with a magnetic coil 100A for an A phase, a magnetic coil 100B for a B phase, a casing 110, a coil back yoke 115, a magnetic sensor 300, a circuit board 310, a connector 320. The rotor 20 is provided with a rotary shaft 230 and a plurality of permanent magnets 200. The rotary shaft 230 is a central shaft of the rotor 20, and the permanent magnets 200 are disposed on the periphery of the rotary shaft 230. Each of the permanent magnets 200 is magnetized along a radial direction (a radiation direction) from the center of the rotary shaft 230 toward the outside. The rotary shaft 230 is supported by bearings 240 of the casing 110. In the present embodiment, a coil spring 260 is disposed inside the casing 110, and the coil spring 260 pushes the rotor 20 toward the left in the drawing to thereby position the rotor 20. It should be noted that the coil spring 260 can be eliminated.

The casing 110 has a roughly cylindrical space in the inside thereof, and a plurality of magnetic coils 100A, 100B is disposed along the inner periphery thereof. It should be noted that in the present embodiment, the magnetic coil 100A for the A phase is disposed on the inner side, and the magnetic coil 100B for the B phase is disposed on the outer side. The magnetic coils 100A, 100B are each a coreless (air-cored) coil. Further, the magnetic coils 100A, 100B and the permanent magnets 200 are disposed so as to be opposed to a cylindrical surface where the rotor 20 and the stator 15 are opposed to each other. Here, the length of the magnetic coils 100A, 100B in the direction parallel to the rotary shaft 230 is set to be greater than the length of the permanent magnets 200 in the direction parallel to the rotary shaft 230. In other wards, when projecting from the permanent magnets 200 in the radiation direction, a part of the magnetic coils 100A, 100B runs off the projection area. The part of the magnetic coils 100A, 100B thus running off is referred to as a “coil end.” Here, when categorizing the magnetic coils 100A, 100B into the coil ends and the other parts, the direction of the force generated by the current flowing through the coil end is a direction (a direction parallel to the rotary shaft 230) different from the rotational direction of the rotor 20, and the direction of the force generated by the current flowing through the other part than the coil end is roughly the same as the rotational direction of the rotor 20. It should be noted that there are two coil ends on both sides of the other part, and the directions of the forces generated in the respective coil ends are opposite to each other, and therefore, the forces cancel each other out as the force applied to the whole of the magnetic coils 100A, 100B. In the present embodiment, the area not overlapping the coil end is referred to as an “effective coil area,” and the area overlapping the coil end is referred to as an “out-of-effective coil area.” The coil back yoke 115 is disposed in the area located outside the magnetic coil 100B in the radiation direction and overlapping the effective coil area. It should be noted that it is preferable that the coil back yoke 115 does not overlap the out-of-effective coil area. If the coil back yoke 115 overlaps the out-of-effective coil area, a vibration, a sound, or a heat is caused by the torque in a different direction from the moving direction of the rotor 20 in the part of the coil back yoke 115 overlapping the out-of-effective coil area, which degrades the efficiency of the electric motor 10 to thereby make it difficult to realize big torque.

The stator 15 is further provided with magnetic sensors 300 as position sensors for detecting the phase of the rotor 20 corresponding respectively to the phases of the magnetic coils 100A, 100B. The magnetic sensors 300 are fixed to the surface of a circuit board 310, and the circuit board 310 is fixed to the casing 110. The circuit board 310 is provided with a control section for controlling the electric motor 10. The circuit board 310 is connected to an external circuit of the electric motor 10 with a connector 320.

FIG. 1B is an explanatory diagram showing the vicinity of the magnetic coils 100A, 100B in an enlarged manner. An insulating layer 701 is disposed between the permanent magnets 200 and the magnetic coil 100A, an insulating layer 702 is disposed between the magnetic coil 100A and the magnetic coil 100B, and an insulating layer 703 is disposed between the magnetic coil 100B and the coil back yoke 115. The distance from the surface of the permanent magnets 200 to the coil back yoke 115 is defined as a length L1, and the distance from the surface of the permanent magnets 200 to the outer periphery of the coil back yoke 115 is defined as a length L2. The lengths L1, L2 will be described later.

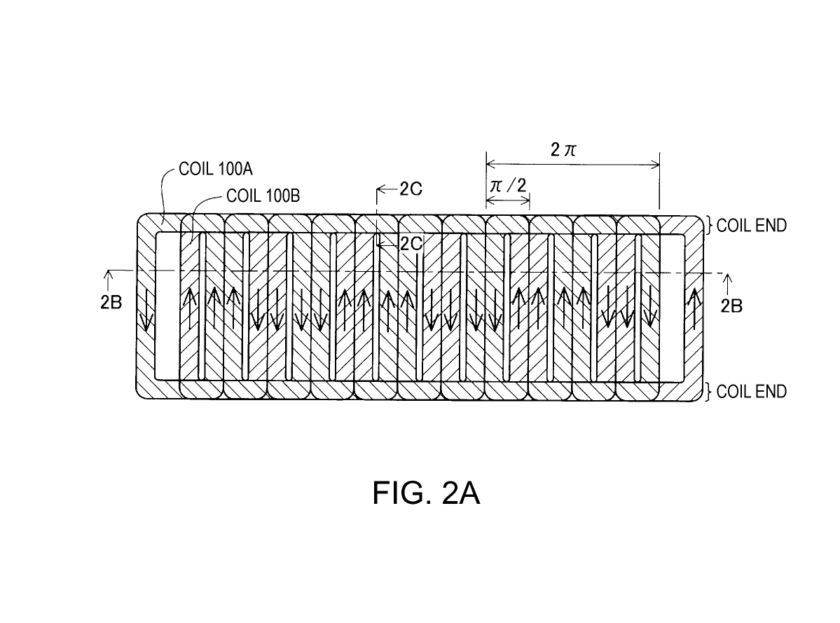

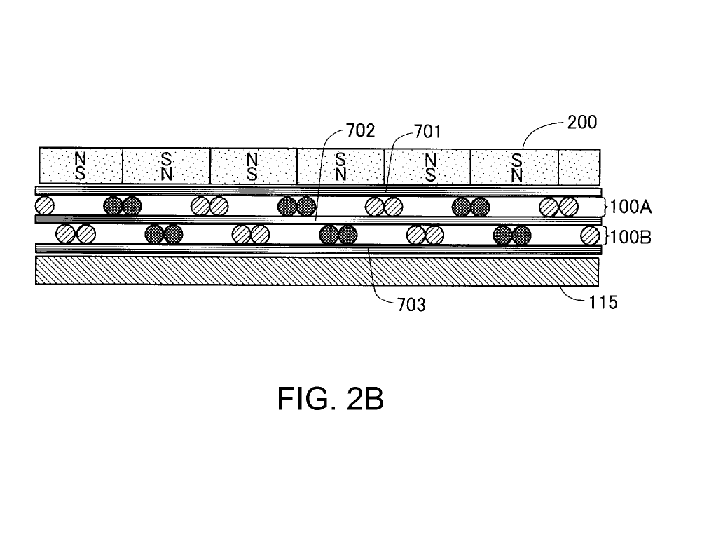

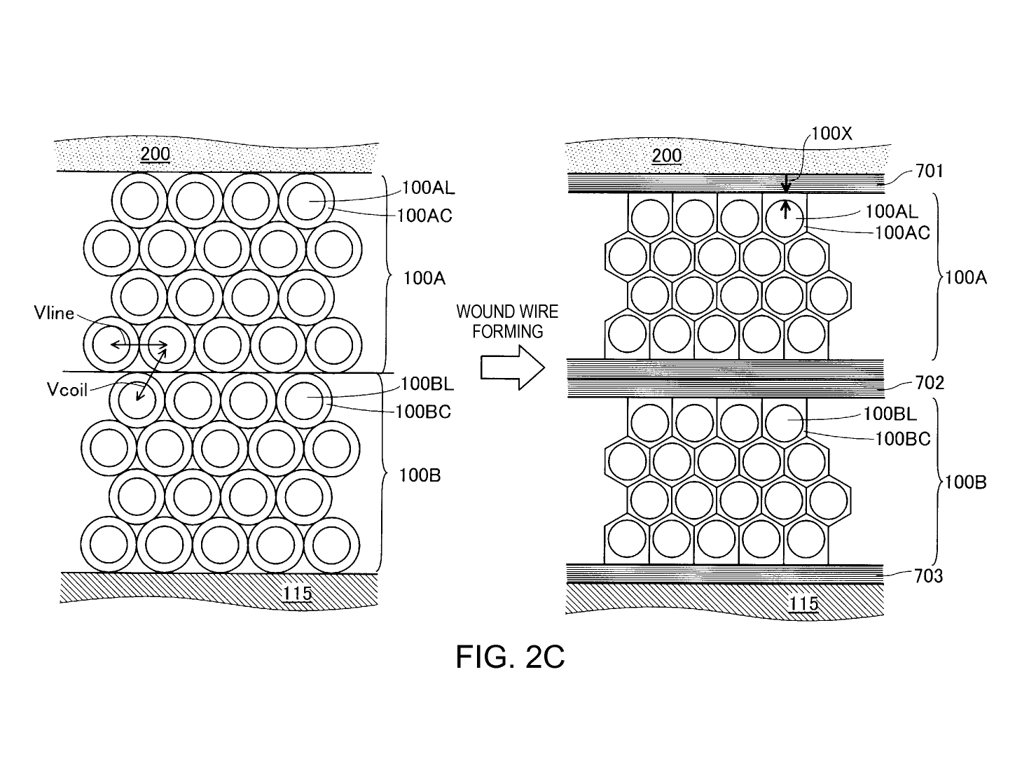

FIG. 2A is an explanatory diagram of the magnetic coils developed along a cylindrical surface on which the magnetic coils are disposed, and viewed from the center of the rotary shaft. FIG. 2B is an explanatory diagram showing the cross-section along the 2B-2B cutting line in FIG. 2A in a developed manner. It should be noted that FIG. 2A only shows the magnetic coils 100A, 100B, but does not show the permanent magnets 200 and the coil back yoke 115 in order to make the drawing easy to read. The magnetic coils 100A, 100B are disposed so as to be shifted π/2 in the electric angle from each other. Further, the magnetic coils 100A, 100B overlap each other in the respective coil ends. The arrows provided to the magnetic coils 100A, 100B indicate directions of the currents flowing through the magnetic coils 100A, 100B at a certain timing. As is obvious from FIG. 2A, the directions of the currents flowing through the magnetic coils 100A, 100B are alternately set to be clockwise and counterclockwise.

FIG. 2C is an explanatory diagram showing the cross-section along the 2C-2C cutting line in FIG. 2A in an enlarged manner. The 2C-2C cutting line cuts the part where the magnetic coils 100A, 100B overlap each other. The left drawing of FIG. 2C shows the state in which the magnetic coils are appropriately wound, then the currents are applied to the magnetic coils to thereby generate Joule heat, and thus the magnetic coils are bound by thermal fusion bonding using the heat. As shown in FIG. 2C, the magnetic coil 100A is formed by winding an electric wire 100AL a plurality of times. The magnetic coil 100B is formed by winding an electric wire 100BL a plurality of times. The electric wires 100AL, 100BL have respective coating 100AC, 100BC. As the coating material of the electric wires 100AL, 100BL, polyester resin can be used, for example. In the state shown in the left drawing of FIG. 2C, there are air spaces in the magnetic coils, which degrade the lamination factor of the wire material. It should be noted that in this case, since a commonly-used insulating layer of the magnetic coil 100A can cope with a high withstand voltage test, the insulating layers 701, 702, and 703 are not required to create the situation of fulfilling the high withstand voltage testing characteristics.

The right drawing of FIG. 2C shows the state in which the magnetic coils are appropriately wound, then heat is applied while pressurizing the magnetic coils in a wound wire forming process to thereby bind the magnetic coils by thermal fusion bonding. In the state shown in the right drawing of FIG. 2C, there is no air space due to the deformation of the insulating layer, and the lamination factor of the wire material is dramatically improved. However, since the pressurization process is performed, the thickness of the coating 100AC is reduced to be 20 through 40% compared to before the wound wire forming process, for example, as indicated by arrows 100X. As a result, there is a possibility that the situation that the coating cannot withstand high voltage is created, and therefore, there is created the situation that the high withstand voltage testing characteristics are not fulfilled between the A-phase magnetic coil 100A and the B-phase magnetic coil 100B, between the A-phase magnetic coil 100A and the permanent magnets 200, and between the B-phase magnetic coil 100B and the coil back yoke 115. Therefore, in the present embodiment, the insulating layers 701, 702, and 703 as the insulating layers are built on the magnetic coils 100A, 100B as described below to thereby achieve the improvement in withstand voltage.

The insulating layer 702 is disposed between the magnetic coils 100A, 100B. Drive voltages (+VDD through −VDD) for driving the electric motor 10 are respectively applied to the magnetic coils 100A, 100B. Here, the phases of the drive voltages applied to the magnetic coils 100A, 100B are shifted from each other. In particular, in the case where PWM drive is performed, since the drive voltage is varied by varying the level of the duty ratio in each of the PWM cycles, there occurs the case in which the voltage of +VDD is applied to the A-phase magnetic coil 100A while the voltage of −VDD is applied to the B-phase magnetic coil 100B to thereby apply the voltage of 2VDD between the magnetic coils 100A, 100B, as a result, depending on the timing. Therefore, the insulating layer 702 is required to have a high withstand voltage property in order to withstand the voltage. Specifically, the withstand voltage Vcoil between the magnetic coils 100A, 100B, namely the insulating layer 702, is defined by the Electrical Appliances and Material Safety Act, the EN standard, or the IEC standard. For example, the Electrical Appliances and Material Safety Act specifies that if the rated voltage is equal to or higher than 150V, there should be provided with the withstand voltage property that the amount of the leakage current is equal to or smaller than 10 mA when applying the voltage of 1,500V for 1 minute. In the case of the rated voltage lower than 150V, the condition of 1,000V for 1 minute is required. In the EN standard and the IEC standard, the condition of 1,500V for 1 minute is required, which is preferable. In contrast, the withstand voltage between the electric wires 100AL adjacent to each other in the magnetic coil 100A, namely the withstand voltage Vline of the coating 100AC, is not required to fulfill the withstand voltage requirement of 1,500V for 1 minute. Because, since the electric wire 100AL has a small electric resistance, the voltage drop in the electric wire 100AL having a length corresponding to several turns is extremely small. As a result, since the electrical potential difference between the electric wires 100AL adjacent to each other is small, the coating 100AC is not required to have such a high withstand voltage property as to withstand the voltage of 1,500V for 1 minute. Substantially the same applies to the coating 100BC of the electric wire 100BL forming the magnetic coil 100B.

As explained with reference to FIG. 1B, the insulating layer 701 is disposed between the permanent magnets 200 and the magnetic coil 100A. The permanent magnets 200 are each made of a magnetic material such as neodymium or ferrite, and have conductivity. Since the permanent magnets 200 are electrically connected to the casing 110 via the rotary shaft 230 and the bearings 240, the electrical potential of the permanent magnets 200 is the ground level. On the other hand, the drive voltage in a range of +VDD through −VDD is applied to the magnetic coil 100A. Therefore, since the voltage is applied between the permanent magnets 200 and the magnetic coil 100A, the insulating layer 701 is required to have a high withstand voltage property in order to prevent the current from leaking between the permanent magnets 200 and the magnetic coil 100A.

Further, the insulating layer 703 is disposed between the magnetic coil 100B and the coil back yoke 115. Similarly, the coil back yoke 115 is made of a magnetic material having conductivity. Since the coil back yoke 115 has contact with the casing 110, the electrical potential of the coil back yoke 115 is the ground level. Similarly, since a voltage in a range of +VDD through −VDD is applied to the magnetic coil 100B, the insulating layer 703 is required to have a high withstand voltage property in order to prevent the current from leaking between the coil back yoke 115 and the magnetic coil 100B.

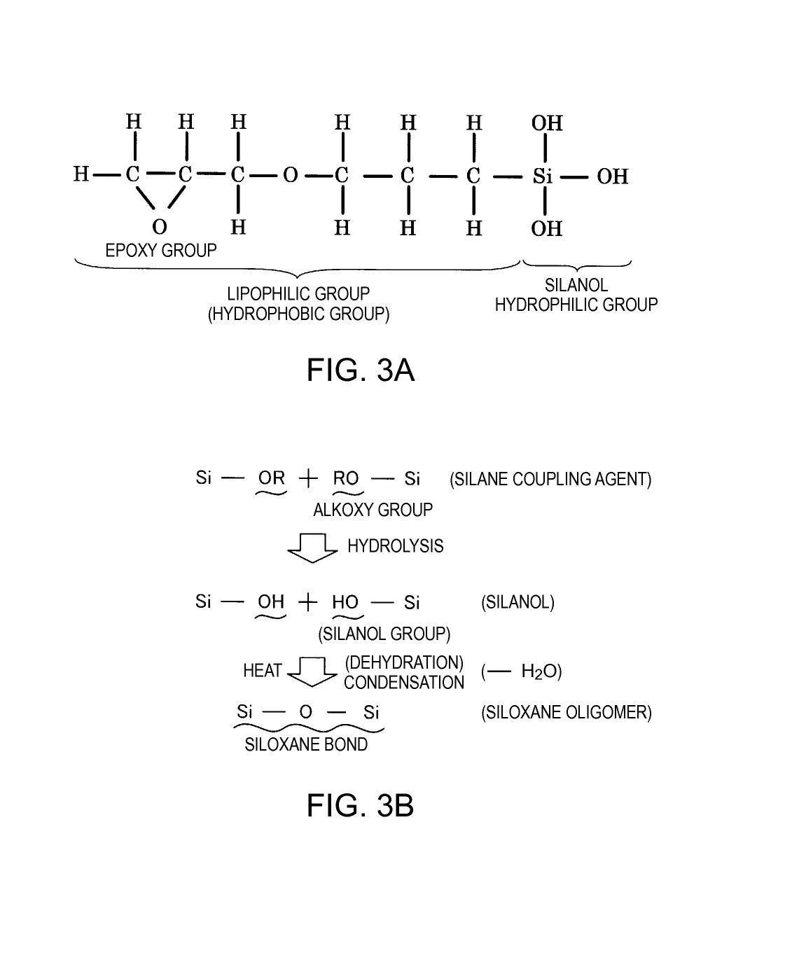

FIGS. 3A and 3B are explanatory diagrams showing an example of a silane coupling agent constituting the insulating layers. The insulating layers 701 through 703 (FIGS. 1A, 1B, and 2C) can be made of the same material. In the present embodiment, a silane coupling agent is included in the insulating layers 701, 702, and 703.

FIG. 3A is an explanatory diagram showing a configuration of silanol as the silane coupling agent. Silanol has a silanol group (Si—OH) and an organic functional group. Since the condensation occurs in the state of the silanol group, it is preferable that the silane coupling agent having an alkoxy group (—OR) is used, and is hydrolyzed to silanol when the conduction occurs.

FIG. 3B is an explanatory diagram showing a silane coupling reaction. The silane coupling agent has an alkoxy group (—OR) binding to silane (Si), and an organic functional group R′. As the alkoxy group, there can be used a variety of alkoxy groups such as a methoxy group (—OCH₃), an ethoxy group (—OC₂H₅), a 2-methoxy-ethoxy group (—OCH₂CH₂—OCH₃). As the organic functional group R′, there can be used either one of an amino group (—NH₂), an epoxy group (see FIG. 3A), a methacryl group (—CO—C(CH₃)═CH₂), a vinyl group (—CH═CH₂), a mercapto group (a thiol group, —SH), and so on.

The silane coupling agent is dissolved in an aqueous solution to thereby prepare a dilute aqueous solution of the silane coupling agent. Subsequently, by processing the dilute aqueous solution under acidic conditions or alkaline conditions, the alkoxy group is hydrolyzed to silanol (Si—OH). The smaller the alkoxy group is, the higher the hydrolysis rate is, and the larger the alkoxy group is, the lower the hydrolysis rate is. Subsequently, the magnetic coil 100A is dipped in the dilute aqueous solution, or the dilute aqueous solution is sprayed to the magnetic coil 100A. On this occasion, silanol formed by the hydrolysis is gradually condensed to form the siloxane bond (Si—O—Si), and then silane oligomer is formed. Since the reaction in this occasion is a dehydration condensation reaction, the condensation reaction can be promoted by eliminating water by heating (e.g., 125° C., 2 hours). Further, silanol binds covalently to the surface of the coating 100AC of the electric wire 100AL of the magnetic coil 100A via hydrogen bond and due to the dehydration condensation reaction, and then forms the insulating layer 702 on the surface of the magnetic coil 100A. The insulating layers 701, 703 can also be formed in substantially the same manner.

FIG. 4 is an explanatory diagram showing an example of the silane coupling agent including titanium oxide or silicon dioxide. In the case of forming the insulating layers 701 through 703 using the silane coupling agent, it is also possible to add titanium oxide (TiO₂) or silicon dioxide (SiO₂) to the silane coupling agent. On this occasion, it is also possible to perform the preparation so that the percentage by mass of the silane coupling agent and the percentage by mass of titanium oxide in the silane oligomer are 47.5 Wt % and 48.5 Wt %, respectively. Further, the silane coupling agent can include antioxidant (4.0%). The structure in which titanium oxide (TiO₂) or silicon dioxide (SiO₂) is distributed in the molecular chain of silane oligomer is obtained. It should be noted that, from the viewpoint of cost, silicon dioxide (SiO₂) is dramatically superior to titanium oxide (TiO₂), and is therefore preferable, and from the viewpoint of high withstand voltage property, silicon dioxide (SiO₂) can provide the high withstand voltage property of withstanding the standard voltage of 1,500Vac or higher even with the thickness of about 20 [μm] according to the data of 10 [μm]-700Vac, 20 [μm]-1,500Vac, and 30 [μm]-2,200Vac.

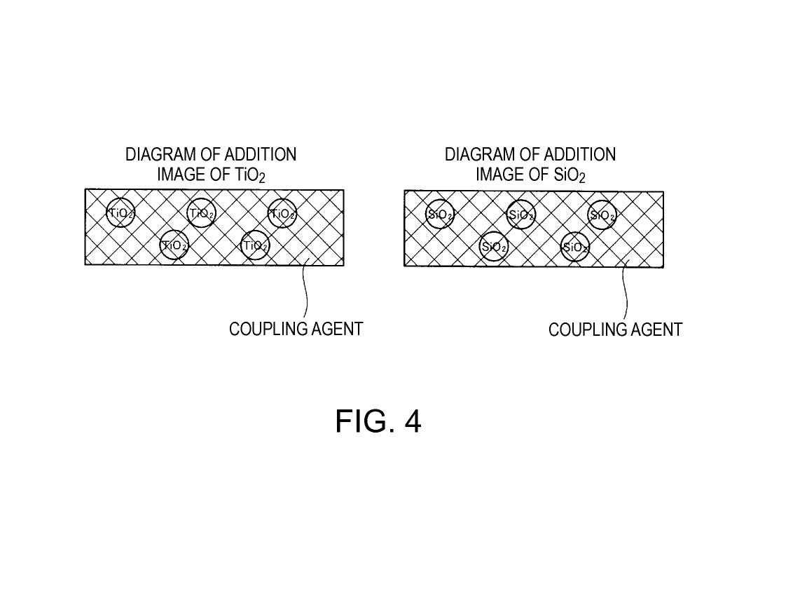

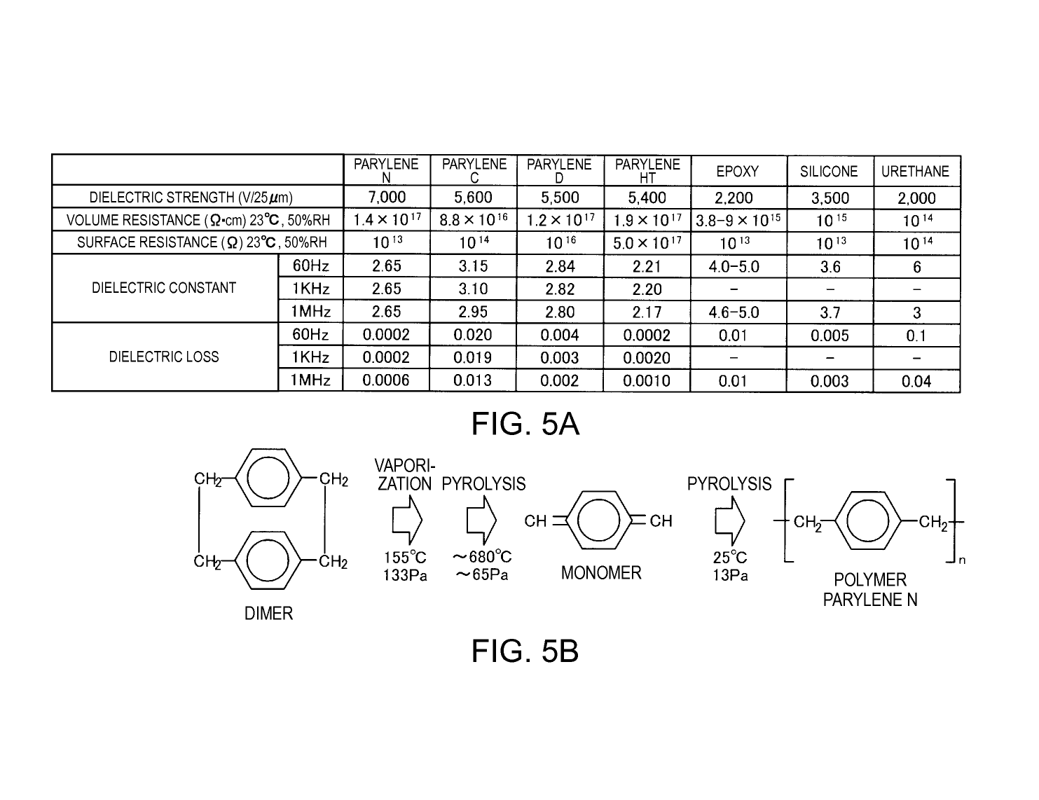

FIGS. 5A and 5B are explanatory diagrams showing other examples of the insulating material. As the constituent material of the insulating layers 701 through 703, there can be used parylene, epoxy, silicone, and urethane besides the silane coupling agent (silane oligomer). Parylene is a generic name of para-xylylene polymers, and has a structure of connecting benzene rings via a methylene group (—CH₂—). By replacing the hydrogen of a benzene ring or the hydrogen of a methylene group with halogen (e.g., chlorine and fluorine), the heat resistance can be enhanced. By using such materials, insulating layers having an enough withstand voltage property with a small thickness can be formed as the insulating layers 701 through 703. As shown in FIG. 5A, parylene has a high withstand voltage property. As shown in FIG. 5B, the insulating layer using parylene can be formed by heating to evaporate raw material dimer, then further heating it to thereby pyrolyze the dimer into monomers, and then vapor-depositing the monomers on the object at room temperature.

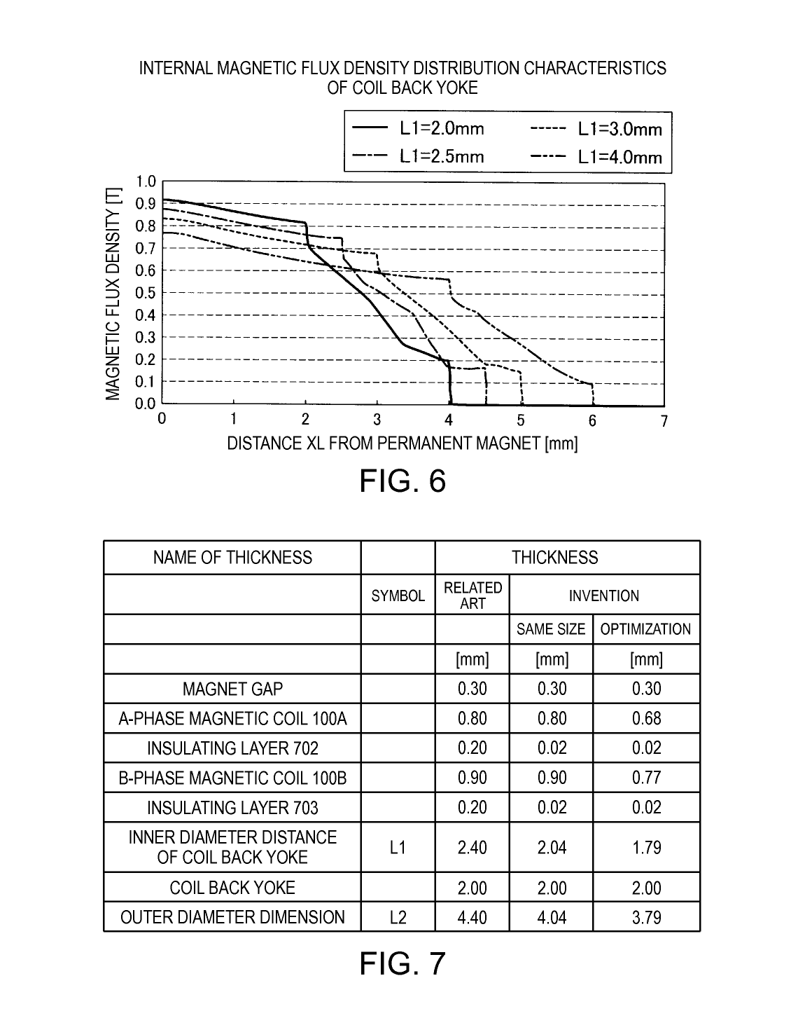

FIG. 6 is an explanatory diagram showing a relationship between the magnetic flux density and the distance XL from the surface of the permanent magnets 200 by the distance L1 between the surface of the permanent magnets 200 and the coil back yoke 115 having a constant thickness (2.0 mm). In FIG. 6, according to the graph corresponding to L1=2.0 mm, the magnetic flux density decreases as the distance XL from the permanent magnets increases. When the distance XL reaches the distance L1=2.0 mm from the surface of the permanent magnets 200 to the coil back yoke 115, since the measurement point enters the coil back yoke 115, the magnetic flux density drops dramatically. Then, at the point of XL=4.0 mm, the measurement point traverses the outer periphery of the coil back yoke 115, and therefore, the magnetic flux density becomes 0[T]. Substantially the same applies to the graphs with L1=2.5, 3.0, and 4.0, and when XL=L1 is achieved, the magnetic flux density drops dramatically. Since the magnetic coils 100A, 100B are disposed in the space between the permanent magnets 200 and the coil back yoke 115, the larger magnetic flux density in this space can improve the performance of the electric motor 10.

It is understood that in the case in which the distance XL from the surface of the permanent magnets 200 takes the same value (e.g., XL=1.0 mm), the magnetic flux density increases as the distance L1 from the surface of the permanent magnets 200 to the coil back yoke 115 decreases. In other words, by reducing the thicknesses of the insulating layers 701 through 703, and the coatings 100AC, 100BC of the electric wires 100AL, 100BL of the magnetic coils 100A, 100B to thereby reduce the distance from the surface of the permanent magnets 200 to the coil back yoke 115, the performance of the electric motor 10 can further be improved.

FIG. 7 is an explanatory diagram for comparing the electric motor according to the invention with an electric motor of related art. In the embodiment of the invention, the material described above is used as the insulating layers 701 through 703 to thereby reduce the thickness of each of the insulating layers 701 through 703. Further, the thickness of each of the coatings 100AC, 100BC is reduced by the process explained with reference to FIG. 2C. Even if the coatings 100AC, 100BC are thinned, the potential difference between the electric wires 100AL adjacent to each other does not become large as described above, and therefore, the current leakage between the electric wires 100AL adjacent to each other hardly occurs. Since the thickness of each of the magnetic coils 100A, 100B and the thickness of each of the insulating layers 702, 703 can be reduced by configuring the electric motor in such a manner as described above, the length L1 corresponding to the distance from the surface of the permanent magnets 200 to the coil back yoke 115 can be reduced. Further, since the magnetic flux density increases as the distance from the surface of the permanent magnets 200 to the coil back yoke 115 decreases, the number of turns of each of the magnetic coils 100A, 100B can be reduced. As a result, it becomes possible to reduce the amount of winding wire used, and at the same time, achieve downsizing of the electric motor 10.

In the case of increasing the thickness of the coating 100AC of the electric wire 100AL of the magnetic coil 100A as in the related art, since the distance between the permanent magnets 200 and the coil back yoke 115 increases due to the thickness of the coating 100AC although the withstand voltage between the magnetic coil and other members can be raised, increase in the magnetic flux density fails to be achieved, and improvement in performance and downsizing of the electric motor are difficult. However, according to the present embodiment, since the thickness of the coating 100AC can be reduced, the distance between the permanent magnets 200 and the coil back yoke 115 can be reduced. As a result, by reducing the diameter of the coil back yoke 115, downsizing of the electric motor 10 can be achieved. Further, since the magnetic flux density can be increased by reducing the distance between the permanent magnets 200 and the coil back yoke 115, the performance of the electric motor 10 can be enhanced.

### B. MODIFIED EXAMPLES

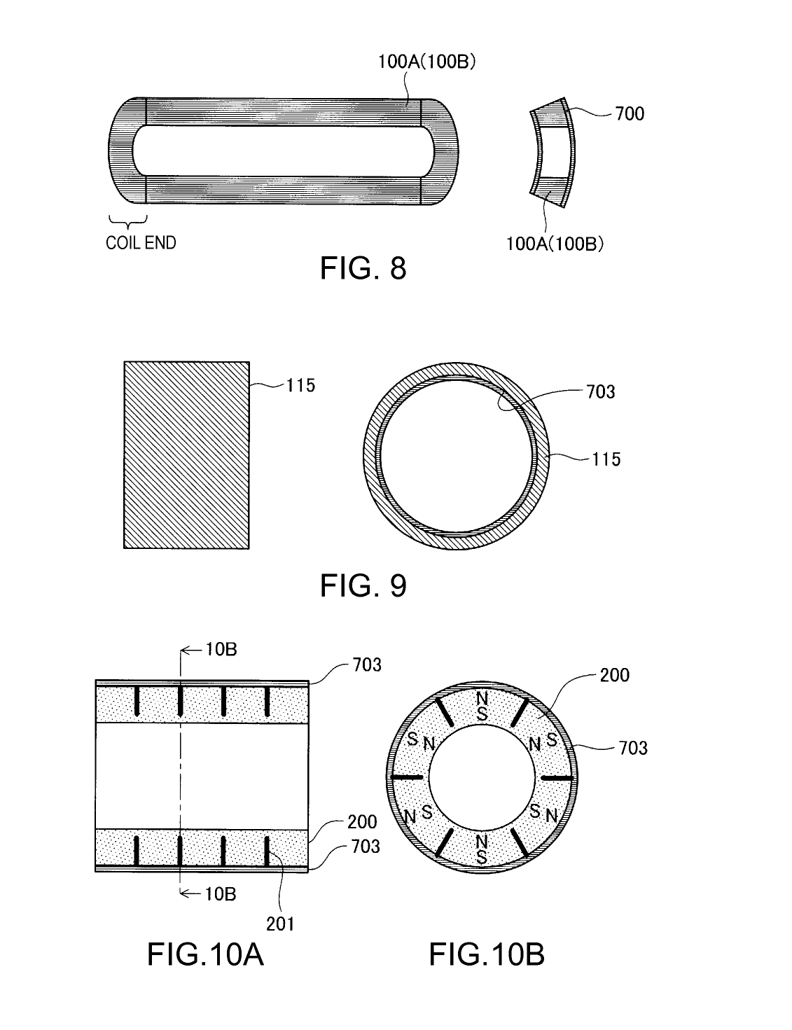

FIG. 8 is an explanatory diagram showing a modified example. In this modified example, the insulating layer 702 is formed only in the upper surface portion and the lower surface portion including the coil ends, out of the magnetic coils 100A, 100B, namely the portions to which insulation is required. As described above, it is also possible to cover only the portions of the magnetic coil to which insulation is required with the insulating layer 702, or to cover the whole of the magnetic coils 100A, 100B with the insulating layer 702.

FIG. 9 is an explanatory diagram showing another modified example. In this modified example, the insulating layer 703 is formed inside (on the magnetic coil 100B side of) the coil back yoke 115. As described above, it is also possible to form the insulating layer 703 on the coil back yoke 115 instead of the magnetic coil 100B.

FIGS. 10A and 10B are explanatory diagrams showing another modified example. In this modified example, the insulating layer 701 is formed on the surface (on the magnetic coil 100A side) of the permanent magnets 200. As described above, it is also possible to form the insulating layer 701 on the permanent magnets 200 instead of the magnetic coil 100A. It should be noted that in this modified example, the permanent magnets 200 have slits 201. Since the insulating layer 701 penetrates into the slits 201, prevention of breakage of the permanent magnets 200 can be achieved by the slits 201. Further, since the strongest torque is applied to the inner periphery of the magnetic coil 100A shown in FIGS. 1A and 1B of the electric motor 10, by disposing the insulating layer 701 in such a place, the insulating layer 701 can make a great contribution to the instantaneous maximum torque characteristics (the characteristics of providing the instantaneous torque approximating the starting torque in a short period of time) of the electric motor 10 as a mechanical reinforcement leading to the strength reinforcement of the magnetic coil 100A besides the purpose of simply performing the electrical insulation.

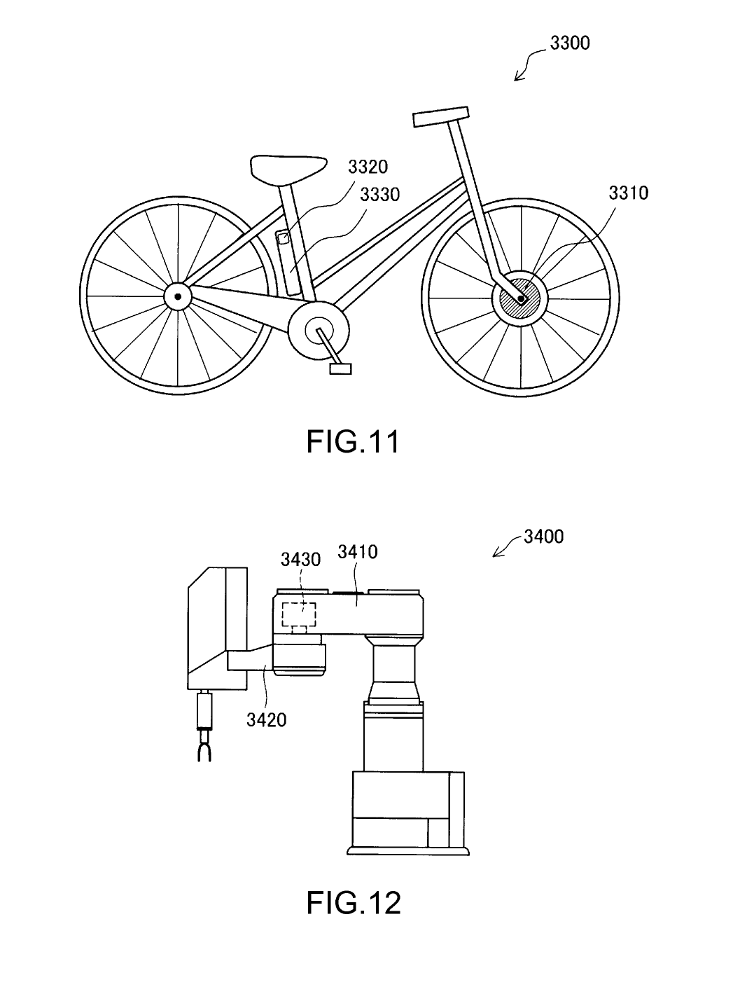

FIG. 11 is an explanatory diagram showing an electric bicycle (an electric power-assisted bicycle) as an example of a movable body using a motor/generator according to another modified example of the invention. The bicycle 3300 has an electric motor 3310 attached to the front wheel, and a control circuit 3320 and a rechargeable battery 3330 disposed on the frame below a saddle. The electric motor 3310 drives the front wheel using the electric power from the rechargeable battery 3330 to thereby assist running. Further, when breaking, the electric power regenerated by the electric motor 3310 is stored in the rechargeable battery 3330. The control circuit 3320 is a circuit for controlling the drive and regeneration of the electric motor. As the electric motor 3310, a variety of types of electric motor 10 described above can be used.

FIG. 12 is an explanatory diagram showing an example of a robot using an electric motor according to another modified example of the invention. The robot 3400 has first and second arms 3410, 3420, and an electric motor 3430. The electric motor 3430 is used when horizontally rotating the second arm 3420 as a driven member. As the electric motor 3430, a variety of types of electric motors 10 described above can be used.

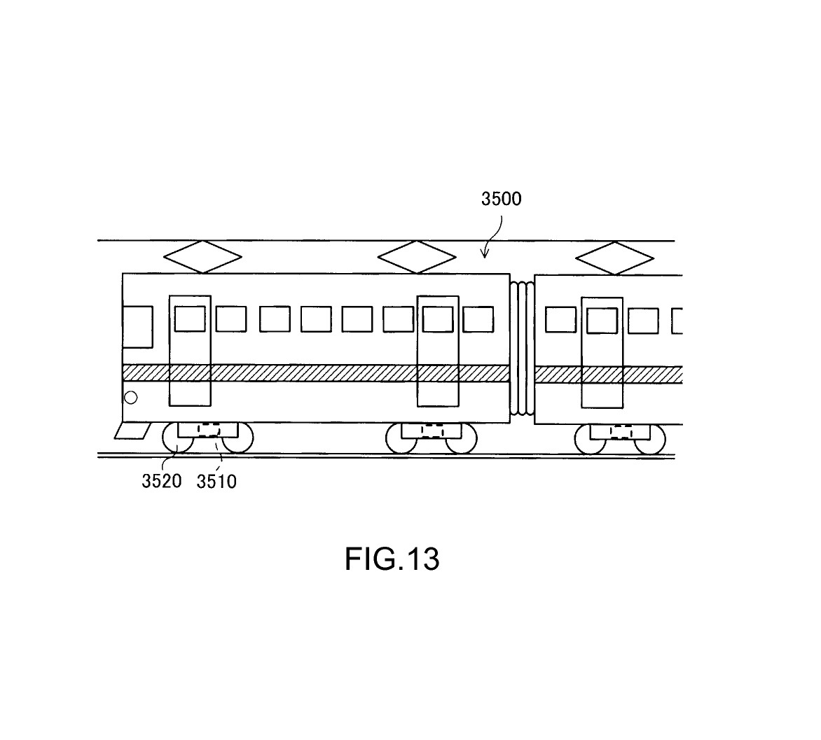

FIG. 13 is an explanatory diagram showing a railroad vehicle using an electric motor according to a modified example of the invention. The railroad vehicle 3500 has an electric motor 3510 and wheels 3520. The electric motor 3510 drives the wheels 3520. Further, the electric motor 3510 is used as a generator when breaking the railroad vehicle 3500, and the electric power is regenerated. As the electric motor 3510, a variety of types of electric motors 10 described above can be used.

Although the embodiments of the invention are hereinabove explained based on some specific examples, the embodiments of the invention described above are only for making it easy to understand the invention, but not for limiting the scope of the invention. It is obvious that the invention can be modified or improved without departing from the scope of the invention and the appended claims, and that the invention includes the equivalents thereof.

The present application claims the priority based on Japanese Patent Application No. 2011-041908 filed on Feb. 28, 2011, the disclosure of which is hereby incorporated by reference in its entirety.

What is claimed is:

1. An electromechanical device comprising:
at least one magnetic coil formed of an electric wire coated with a first insulating material wound a plurality of times to have a ring-like shape; and
an insulating section made of a second insulating material and disposed so as to cover at least a part of the magnetic coil,
wherein a withstand voltage between an outside of the insulating section and the magnetic coil across the insulating section is higher than a withstand voltage between the electric wires adjacent to each other in the magnetic coil.

2. The electromechanical device according to claim 1, wherein
the withstand voltage of the insulating section fulfills a withstand voltage value specified by a standard related to the electromechanical device, and
the withstand voltage between the electric wires adjacent to each other in the magnetic coil is lower than the withstand voltage value specified by the standard.

3. The electromechanical device according to claim 1, further comprising:
a permanent magnet disposed so as to be opposed to the magnetic coil,
wherein the insulating section is disposed on the permanent magnet side of the magnetic coil.

4. The electromechanical device according to claim 1, further comprising:
a coil back yoke,
wherein the magnetic coil is disposed between the permanent magnet and the coil back yoke, and
the insulating section is disposed between the magnetic coil and the coil back yoke.

5. The electromechanical device according to claim 1, wherein
a number of the magnetic coils is plural, and
the insulating section is disposed between the plurality of magnetic coils.

6. The electromechanical device according to claim 1, wherein
the second insulating material is selected from a group consisting of a titanium oxide-containing silane coupling agent, parylene, epoxy, silicone, and urethane.

7. A movable body comprising the electromechanical device according to claim 1.

8. A movable body comprising the electromechanical device according to claim 2.

9. A movable body comprising the electromechanical device according to claim 3.

10. A movable body comprising the electromechanical device according to claim 4.

11. A movable body comprising the electromechanical device according to claim 5.

12. A movable body comprising the electromechanical device according to claim 6.

13. A robot comprising the electromechanical device according to claim 1.

14. A robot comprising the electromechanical device according to claim 2.

15. A robot comprising the electromechanical device according to claim 3.

16. A robot comprising the electromechanical device according to claim 4.

17. A robot comprising the electromechanical device according to claim 5.

18. A robot comprising the electromechanical device according to claim 6.
